(19) United States
(12) Patent Application Publication
(10) Pub. No.: US 2018/0032698 A1
(43) Pub. Date: Feb. 1, 2018

(54) TECHNOLOGY FOR DYNAMICALLY GENERATING HEALTH-RELATED AND CUSTOMIZED RECOMMENDATIONS FOR INDIVIDUALS

(71) Applicant: SHAKLEE CORPORATION, Pleasanton, CA (US)

(72) Inventors: Francis C. Lau, Pebble Beach, CA (US); Bruce P. Daggy, Pleasanton, CA (US); Jamie F. McManus, Discovery Bay, CA (US)

(21) Appl. No.: 15/663,129

(22) Filed: Jul. 28, 2017

Related U.S. Application Data
(60) Provisional application No. 62/368,644, filed on Jul. 29, 2016.

(51) Int. Cl. G06F 19/00; G06Q 50/00

(52) U.S. Cl. CPC G06F 19/3431; G06Q 50/01; G06F 19/363

(57) ABSTRACT

Systems and methods for dynamically generating health-related recommendations are described. In certain aspects, an individual may use an electronic device to access a set of interfaces supported by a back-end server, where the set of interfaces may enable the individual to make selections and input information. The back-end server may examine and analyze the selections and information, and accordingly determine and generate a set of health-related recommendations for the individual, where the individual may use the electronic device to select and purchase one or more products or services included in set of health-related recommendations.

### CROSS-REFERENCE TO RELATED APPLICATIONS

This application claims priority to U.S. Patent Application Ser. No. 62/368,644, filed Jul. 29, 2016, which is incorporated herein by reference in its entirety.

### FIELD

The present disclosure is directed to technology for assessing the general health and wellbeing of individuals and dynamically generating health-related recommendations for the individuals.

### BACKGROUND

Individuals of all ages often seek to improve their levels of health through various diet improvements, lifestyle and exercise adjustments, and/or other methods. In certain situations, an individual may seek medical advice which entails a licensed physician prescribing certain medications or products. In other situations, an individual may purchase certain health-related products that are available without a prescription. These products are generally known as nutraceuticals, and may include nutrients, dietary supplements, herbal products, and/or specific diets or processed food (e.g., cereals, soups, beverages). Among other benefits, nutraceuticals help insure that individuals receive proper nourishment by supplying key nutrients including vitamins, minerals, omega-3 fatty acids, and other nutrients.

Studies have shown that regular consumption of nutraceuticals offers a wide variety of health benefits, such as lowering disease risk factors (e.g. triglycerides, homocysteine, C-reactive protein levels, cholesterol to HDL ratio), correcting deficiencies of vitamins and minerals, and lowering the risk of diseases including high blood pressure, diabetes, and cardiovascular disease. Further, users of nutraceutical products often report higher levels of health when compared to non-users.

However, many individuals might not be aware of their nutritional gaps. Additionally, there are many manufacturers and distributors of nutraceuticals, as well as varied nutraceutical products themselves. It is time-consuming, expensive, and overwhelming for individuals to evaluate their nutritional gaps and to research available nutraceutical products and/or product plans, and ultimately select nutraceutical products and/or product plans that reflect health goals of individuals.

Accordingly, there is an opportunity for platforms and techniques to dynamically determine nutraceutical products and/or product plans that reflect individual health goals, and automatically offer the nutraceutical products and/or product plans to individuals for review and purchase.

### SUMMARY

According to embodiments, a computer-implemented method of dynamically generating health-related recommendations is provided. The method may include enabling an electronic device to access an interface configured to receive a set of inputs from a user of the electronic device, receiving, from the electronic device via a network connection, the set of inputs associated with the interface, the set of inputs including a set of health-related information associated with the user, and determining, by a computer processor based on at least a portion of the set of inputs, (i) a health assessment for the user, and (ii) a set of proposed health-related recommendations for the user, each of the set of proposed health-related recommendations indicating a set of products available for purchase. The method may further include transmitting, to the electronic device via the network connection, data indicative of the health assessment and the set of proposed health-related recommendations, the electronic device configured to enable the user to make a set of selections associated with the set of health-related recommendations.

In another embodiment, a server configured to dynamically generate health-related recommendations is provided. The server may include a transceiver configured to communicate data via at least one network connection, a memory storing a set of computer-readable instructions, and a processor interfacing with the transceiver and the memory. The processor may be configured to execute the set of computer-readable instructions to cause the processor to enable an electronic device to access an interface configured to receive a set of inputs from a user of the electronic device, receive, from the electronic device via the transceiver, the set of inputs associated with the interface, the set of inputs including a set of health-related information associated with the user, determine, based on at least a portion of the set of inputs, (i) a health assessment for the user, and (ii) a set of proposed health-related recommendations for the user, each of the set of proposed health-related recommendations indicating a set of products available for purchase, and transmit, to the electronic device via the transceiver, data indicative of the health assessment and the set of proposed health-related recommendations, the electronic device configured to enable the user to make a set of selections associated with the set of health-related recommendations.

### BRIEF DESCRIPTION OF THE FIGURES

FIG. 1 depicts an overview of an example system of components configured to facilitate functionalities related to the health-related recommendations, in accordance with some embodiments.

FIG. 2 depicts an example block diagram associated with providing information and dynamically generating health-related recommendations, in accordance with some embodiments.

FIGS. 3, 4A, 4B, 5-17, 18A, 18B, 19A, 19B, and 20 depict example interfaces associated with providing health information and health-related recommendations, in accordance with embodiments.

FIG. 21 depicts an example block diagram associated with providing information and dynamically generating health-related recommendations, in accordance with some embodiments.

FIGS. 22A and 22B depict example flow diagrams associated with dynamically generating health-related recommendations, in accordance with some embodiments.

FIG. 23 is a block diagram of an example server, in accordance with some embodiments.

### DETAILED DESCRIPTION

The present embodiments may relate to, inter alia, dynamically and automatically generating health-related recommendations for individuals. According to certain aspects, the individuals may use electronic devices to access and interact with a set of interfaces that are supported by a back-end server, where the set of interfaces include questions and selections related to health-specific matters as well as certain individual preferences (e.g., pricing preferences).

The individuals may use the electronic devices to input information and make selections within the set of interfaces, and the back-end server may compile and analyze the inputted information and selections. In particular, the back-end server may compile and analyze the information for each individual to determine parameters representative of a current health state for that individual. In an implementation, the parameters may include a current diet state representative of that individual's diet intake and a current lifestyle state representative of that individual's activities and lifestyle choices. The back-end server may dynamically and automatically generate one or more health-related recommendations for that individual based on the parameters as well as any inputted preferences. Each of the health-related recommendations may include one or more products or services that the individual may select to purchase. The recommendations may further include a set of suggestions for diet and lifestyle modifications.

The systems and methods therefore offer numerous benefits. In particular, the systems and methods enable individuals to be provided with tailored, effective health-related recommendations. Additionally, the systems and methods automatically and dynamically generate the health-related recommendations based on received information such that the individuals are afforded the benefit of prompt receipt of the recommendations. The systems and methods further enable the individuals to select to purchase one or more of the products and services included in the health-related recommendations, and the systems and methods may support electronic check out and purchase functionalities. Further, the individuals are afforded the health benefits of consuming or using the purchased products and services. Moreover, individuals may use the systems and methods repeatedly to adjust or improve their health goals. It should be appreciated that other benefits are envisioned.

The systems and methods discussed herein address a business challenge, namely a business challenge related to improving the effectiveness of offering health-related recommendations to individuals. In conventional scenarios, individuals must manually research certain products and services, which is ineffective and time consuming. Additionally, although individuals may consult specialists, these consultations are also time consuming and often prove expensive. In contrast, the systems and methods enable individuals to efficiently and effectively input information related to their diet and lifestyle, automatically analyze the inputted information to determine health-related recommendations for the individuals, and enable the individuals to access an online portal using a variety of digital devices commonly available to purchase products and services included in the health-related recommendations.

Therefore, the systems and methods do not merely recite the performance of some business practice known from the pre-Internet world (providing health recommendations) along with the requirement to perform it on the Internet. Instead, the systems and methods incorporate computer networks that enable communications between a back-end server and electronic devices operated by users. Thus, the systems and methods are necessarily rooted in computer technology in order to overcome a problem specifically arising in computer networks. Further, the systems and methods discussed herein address technical challenges, namely automatically and dynamically establishing dynamic data collection, analysis, and communication among multiple electronic devices.

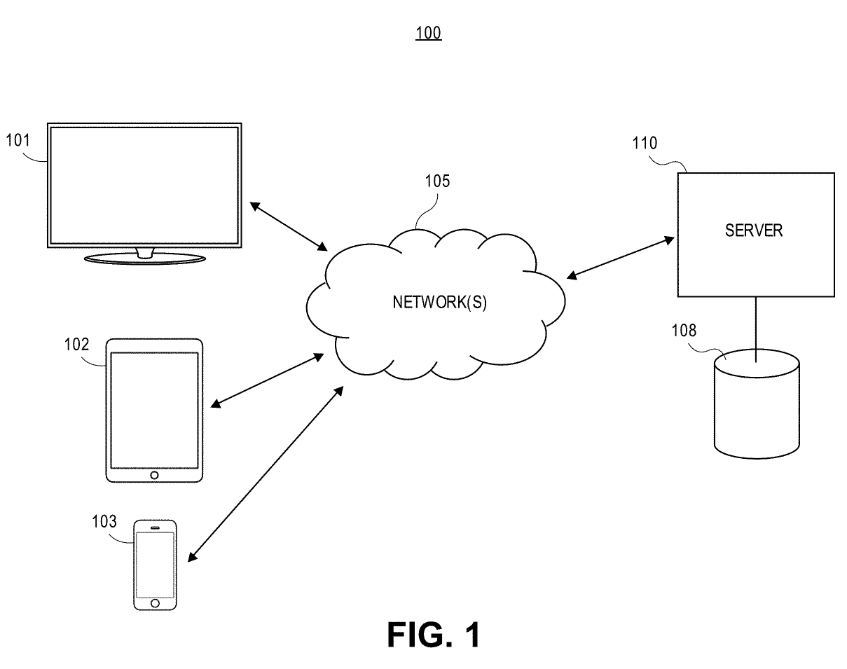

FIG. 1 illustrates an overview of a system 100 of components configured to facilitate the systems and methods. It should be appreciated that the system 100 is merely an example and that alternative or additional components are envisioned.

As illustrated in FIG. 1, the system 100 includes a set of electronic devices 101, 102, 103. According to embodiments, each of the electronic devices 101, 102, 103 may be any type of electronic device such as a mobile device (e.g., a smartphone), desktop or notebook computer, tablet, phablet, GPS (Global Positioning System) or GPS-enabled device, smart watch, smart glasses, smart bracelet, wearable electronic, PDA (personal digital assistant), pager, computing device configured for wireless communication, and/or the like. Although FIG. 1 depicts three (3) electronic devices, it should be appreciated that more or fewer electronic devices are envisioned.

The system 100 may further include a server 110. According to embodiments, the server 110 may include any combination of hardware and software components, and may be associated with any type of entity (e.g., company, business, corporation) or individual. The server 110 may support execution of one or more modules or applications configured to facilitate the systems and methods. Further, the server 110 may interface with a database 108 or other type of memory configured to store data accessible by the server 110 and/or components thereof.

Each of the electronic devices 101, 102, 103 may be configured to communicate with the server 110, and vice-versa, via one or more computer networks 105. In embodiments, the computer network(s) 105 may support any type of wired or wireless data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others). As an example, the electronic device 103 may communicate with the server 110 via an LTE connection.

According to embodiments, the server 110 may host, support, and/or manage a set of interfaces that are accessible by each of the electronic devices 101, 102, 103. In an implementation, the server 110 may host a webpage or website that may include the set of interfaces and that may be accessible by each of the electronic devices 101, 102, 103. In another implementation, each of the electronic devices 101, 102, 103 may download and install a dedicated application that supports the set of interfaces, where the dedicated application may communicate with the server 110 via the computer network(s) 105. It should be appreciated that additional or alternative mediums for the electronic devices 101, 102, 103 to access the set of interfaces are envisioned.

According to embodiments, each of the set of electronic devices 101, 102, 103 may interface with a set of additional electronic devices (not shown in FIG. 1) via various wired or wireless connections, such as the computer network(s) 105. The set of additional electronic devices may include a monitor device (e.g., a blood pressure monitor, a heart rate monitor, an electrocardiograph monitor, a breathing rate monitor, a sleep monitor, continuous or non-continuous monitors for blood oxygen, blood electrolytes, blood lipids and blood glucose, etc.), a fitness tracker having incorporated various sensors, and/or other devices capable of collecting health-related data or information from a user including weight scales and body fat analyzers.

Each of the set of additional electronic devices may be configured with one or more sensors (e.g., accelerometers, location modules, gyroscopes, etc.) that may collect data during operation of the additional electronic device. Each of the set of additional electronic devices may transmit the collected data to the electronic device via a network connection, such as various local-, wide-, or personal-area network connections (e.g., the computer network(s) 105). In an implementation, the additional electronic device(s) may automatically connect to and transmit the collected data to any of the electronic devices 101, 102, 103 as the additional electronic device(s) collects the data. In another implementation, the any of the electronic devices 101, 102, 103 may connect to the additional electronic device(s) and retrieve the collected data.

Generally, the collected data may be representative of health-related information, and may be in a raw data format. Accordingly, the electronic device may analyze the collected data to identify patterns or other metrics that may be representative of certain user inputs. The patterns or other metrics may represent a set of improvement areas for the user and/or a set of presumed health goals for the user. For example, if the collected data is a blood pressure reading, the electronic device may determine that the blood pressure level for the user is high and that an improvement area is to decrease blood pressure. As another example, if the collected data is a pedometer reading that indicates an average of 8,000 steps/day for a user, then the electronic device may determine that a goal for the user is to achieve 10,000 steps/day.

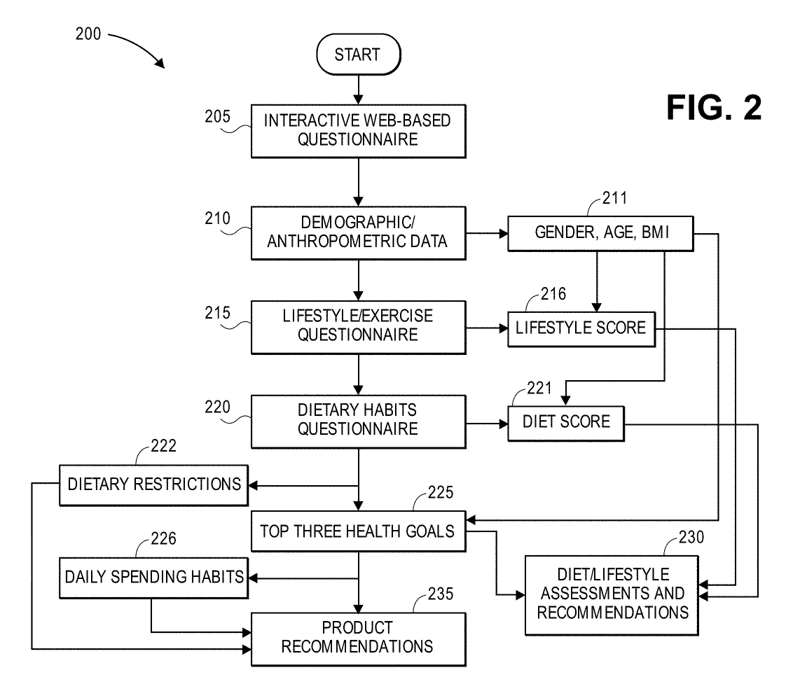

FIG. 2 depicts a block diagram 200 associated with providing information and dynamically generating health-related recommendations. The block diagram 200 may be facilitated by one or more electronic devices, such as the server 110 and/or any of the electronic devices 101, 102, 103 as discussed with respect to FIG. 1. Generally, a user may use an electronic device to input information and make selections, and a server may facilitate various functionalities based on the information and selections.

At block 205, the server may provide an interactive web-based questionnaire that may be accessible by the electronic device as a set of interfaces. In embodiments, the user may use the electronic device to make selections and input information into the interactive web-based questionnaire. In particular, at block 210, the user may input demographic information (e.g., gender, age, etc.) and anthropometric information (e.g., weight, height, etc.). Based on the demographic information and the anthropometric information, the server may compile certain data, as indicated in block 211 (as shown: a gender, age, and body mass index (BMI)).

At block 215, the user may respond to a lifestyle and exercise questionnaire. In particular, the lifestyle and exercise questionnaire may enable the user to input information related to certain lifestyle habits and activities, as well as information associated with exercise activity. Using the information from the lifestyle and exercise questionnaire as well as the data included in block 211, the server may calculate a lifestyle score indicated by block 216. In an implementation, the lifestyle score may be a numerical score in the range of 0-100 (or another type of score), and may be reflective of an overall quality of the lifestyle of the user.

At block 220, the user may respond to a dietary habits questionnaire. In particular, the dietary habits questionnaire may enable the user to input information related to dietary activities and habits. Using the information from the dietary habits questionnaire as well as the data include in block 211, the server may calculate a diet score indicated by block 221. In an implementation, the diet score may be a numerical score in the range of 0-100 (or another type of score), and may be reflective of an overall quality of the diet of the user.

At block 222, the user may input any dietary restrictions. For example, the user may specify one or more of gluten free, soy free, nut free, dairy free, vegetarian, kosher, or other restrictions. Additionally, at block 225, the user may input one or more health goals, such as overall health, healthy heart, joint comfort, strong bones, healthy aging, immune support, sharp memory and focus, more energy, healthy digestion, weight loss, better sleep, stress reduction, staying fit, and/or other health goals. In embodiments, the one or more health goals may be at least partly based on the data included in block 211. Further, at block 226, the user may input daily spending habits. In particular, the user may input a periodic desired spending amount (e.g., desired amount to spend each day) for any available products or services associated with a health-related recommendation.

At block 230, the server may determine and generate a set of diet and lifestyle assessments and recommendations for the user. In particular, as depicted in FIG. 2, the server may determine and generate the assessments and recommendations based on one or more of the lifestyle score (block 216), the diet score (block 221), and the data included in blocks 211 and 225. The diet and lifestyle assessments may indicate respective qualities of the user's diet and lifestyle habits and activities, and the recommendations may indicate tips or improvements for the user's diet and lifestyle habits and activities.

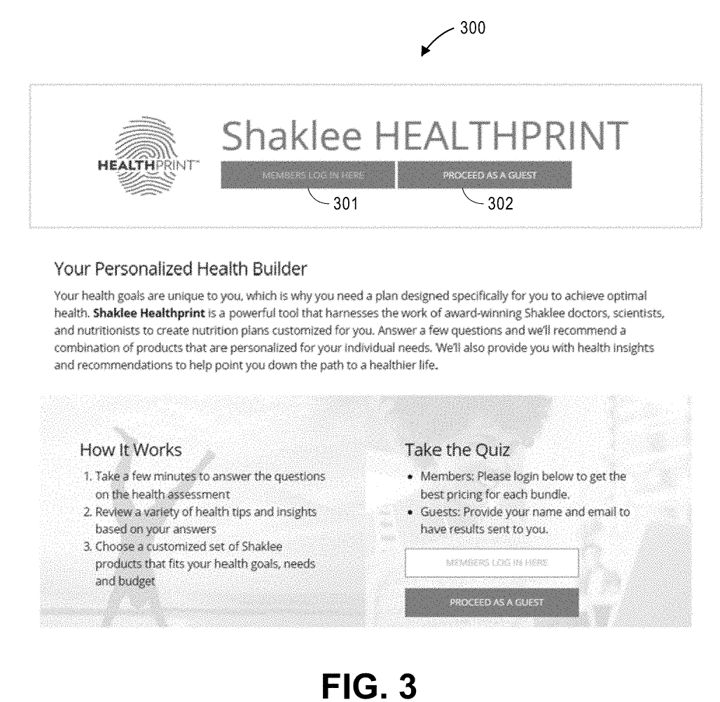

At block 235, the server may determine and generate product recommendations for the user. In particular, as depicted in FIG. 2, the server may determine and generate the product recommendations based on one or more of the health goals of block 225, any dietary restrictions as indicated in block 221, and the daily spending habits of block 226. In embodiments, the product recommendations may be divided into multiple price points, where each product recommendation may indicate at least one product and/or service that is available for purchase by the user. Additionally, to determine and generate the product recommendations, the server may examine one or more lookup tables according to the user-inputted information, where the one or more lookup tables include the products. The inputs and functionalities associated with FIG. 2 are hereinafter described with respect to FIGS. 3-17, 18A, 18B, 19A, 19B, and 20.

Generally, one or more electronic devices, such as the server 110 and/or any of the electronic devices 101, 102, 103 as discussed with respect to FIG. 1, may compile and aggregate data associated with usage of the systems and methods by users. In particular, the electronic device(s) may compile and aggregate data indicating user-supplied information, the determined health-related recommendations, the determined health assessments, the product recommendations, which products the users purchase, and the relationships therebetween. For example, the electronic device may determine which products users purchase most often, based on the determined recommendations, assessments, user-supplied information (e.g., demographic characteristics, top concerns), and/or product needs.

The electronic device(s) may utilize this information to improve the systems and methods. In particular, the electronic device(s) may suggest where additional content might be helpful to the users, and/or suggest where additional products could be recommended (e.g., to address an unmet or unanticipated need). Further, the electronic device(s) may facilitate testing to determine, for example, how variations in system logic or language impact end user behavior (e.g., completing the assessment, placing a product order, or using the assessment for ongoing monitoring). It should be appreciated that additional modifications are envisioned based on data collected through usage of the systems and methods.

FIGS. 3, 4A, 4B, 5-17, 18A, 18B, 19A, 19B, and 20 illustrate example interfaces associated with assessing individual health and wellbeing, and generating health-related recommendations. One or more electronic devices (e.g., a notebook computer or a smartphone) may be configured to display the interfaces and/or receive selections and inputs from a user via the interfaces. For example, a dedicated application that is configured to operate on the electronic device may display the interfaces, where the user may use the electronic device to view and interact with the interfaces. It should be appreciated that the interfaces and the content thereof are merely exemplary and that alternative or additional content is envisioned. According to embodiments, the electronic device may interface with a back-end server (e.g., the server 110 as discussed with respect to FIG. 1) to retrieve information related to information presented in the interfaces as well as navigation among the interfaces.

FIG. 3 depicts an initial interface 300 that may describe the assessment functionalities and may enable the user to begin a health assessment. The initial interface 300 may enable the user to log in as a member via a selection 301, or to proceed as a guest via a selection 302.

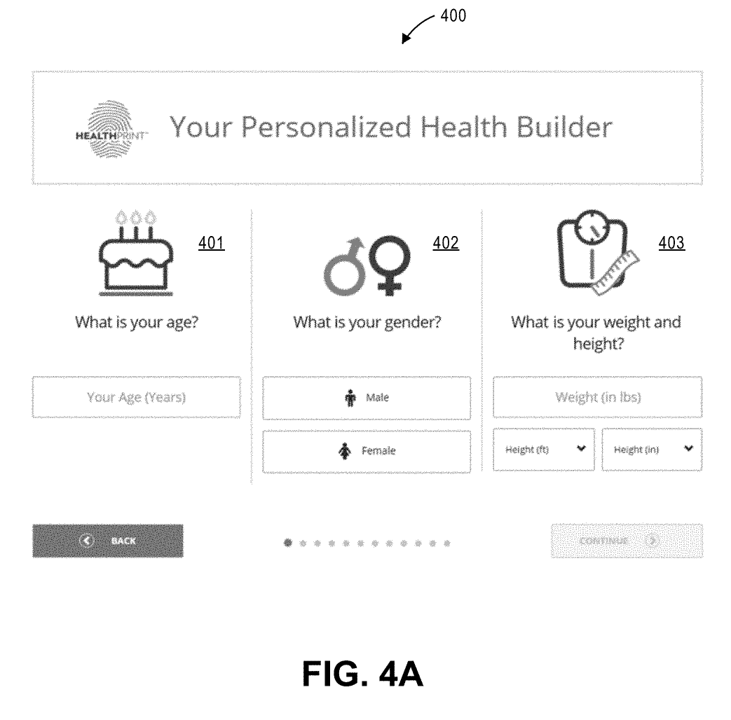

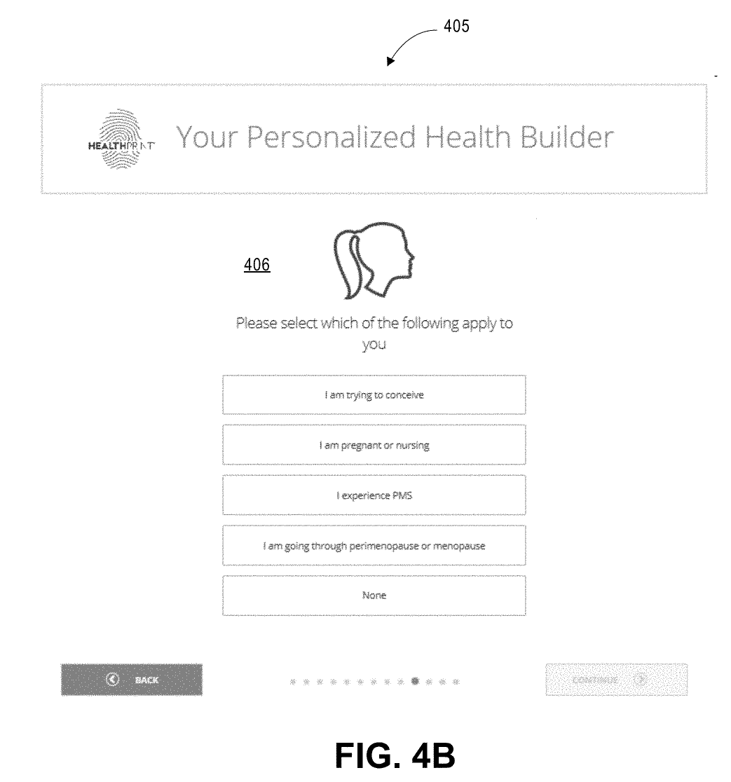

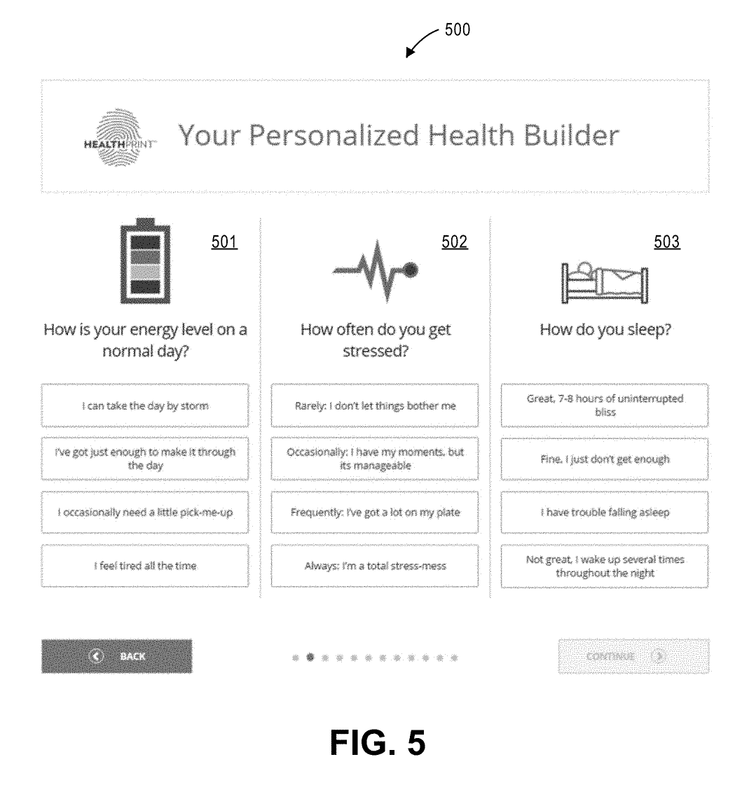

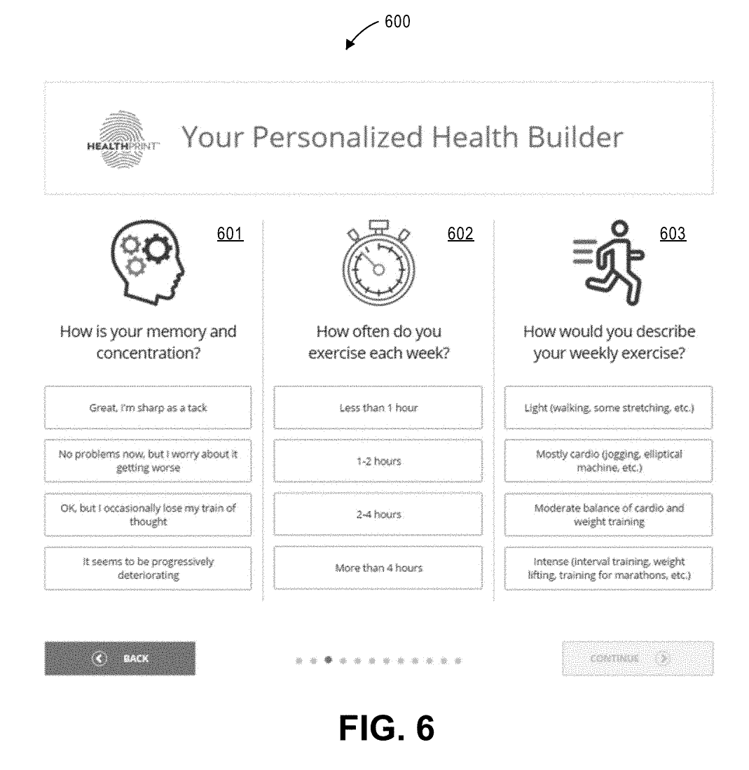

FIG. 4A depicts an interface 400 with a set of questions for the user to answer. In particular, the interface 400 enables the user to input his/her age (401), gender (402), and weight and height (403). FIG. 4B depicts an interface 405 that may be displayed if the user selects “Female” as the gender. The interface 405 enables the user to input certain situations (406) that may apply to the user. FIG. 5 depicts an interface 500 that enables the user to select his/her energy level (501), stress frequency (502), and sleep habits (503). FIG. 6 depicts an interface 600 that enables the user to select a memory/concentration metric (601), exercise frequency (602), and exercise description (603).

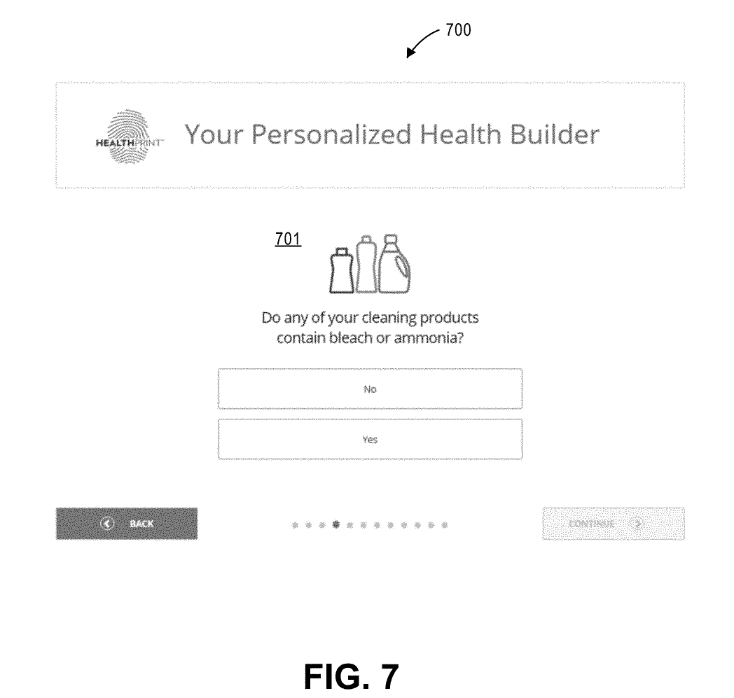

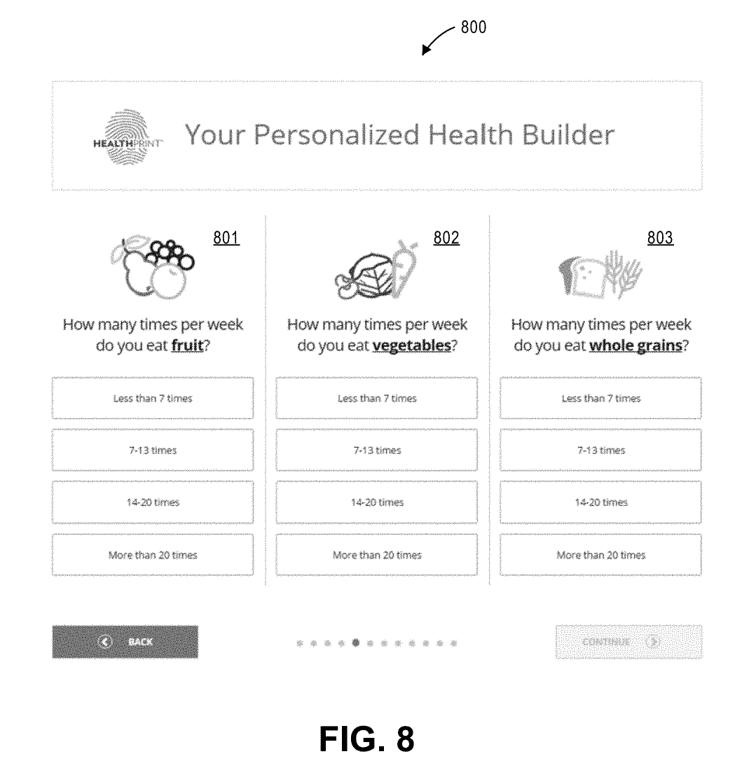

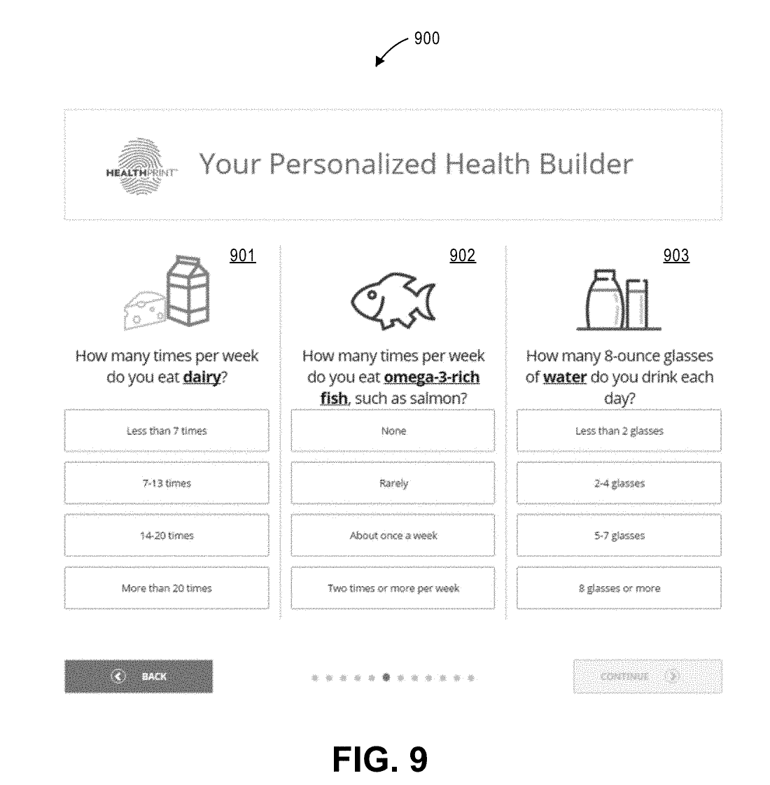

FIG. 7 depicts an interface 700 that enables the user to select a bleach or ammonia presence in cleaning products (701) within a residence of the user. FIG. 8 depicts an interface 800 that enables the user to select a fruit consumption amount (801), a vegetable consumption amount (802), and a whole grain consumption amount (803). FIG. 9 depicts an interface 900 that enables the user to select a dairy consumption amount (901), a fish consumption amount (902), and a water consumption amount (903).

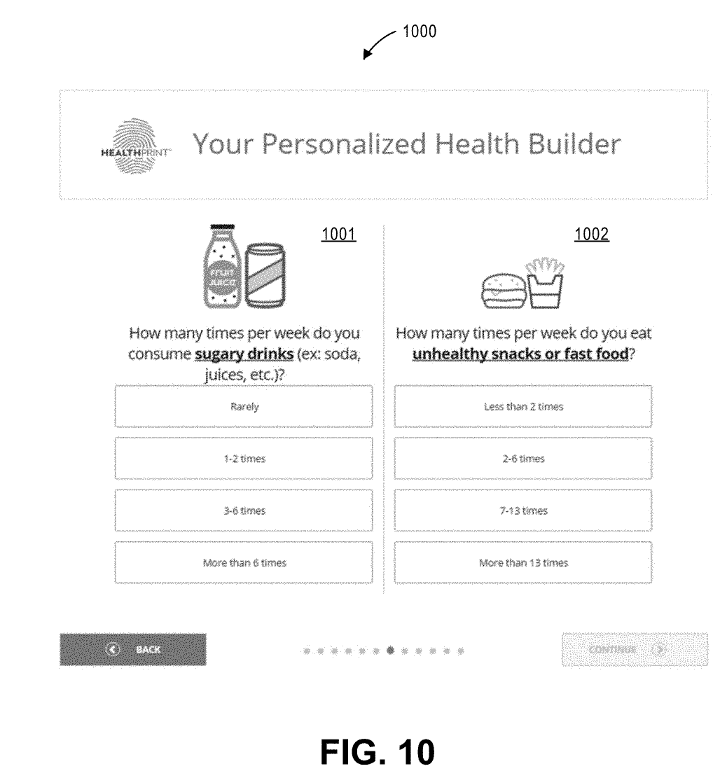

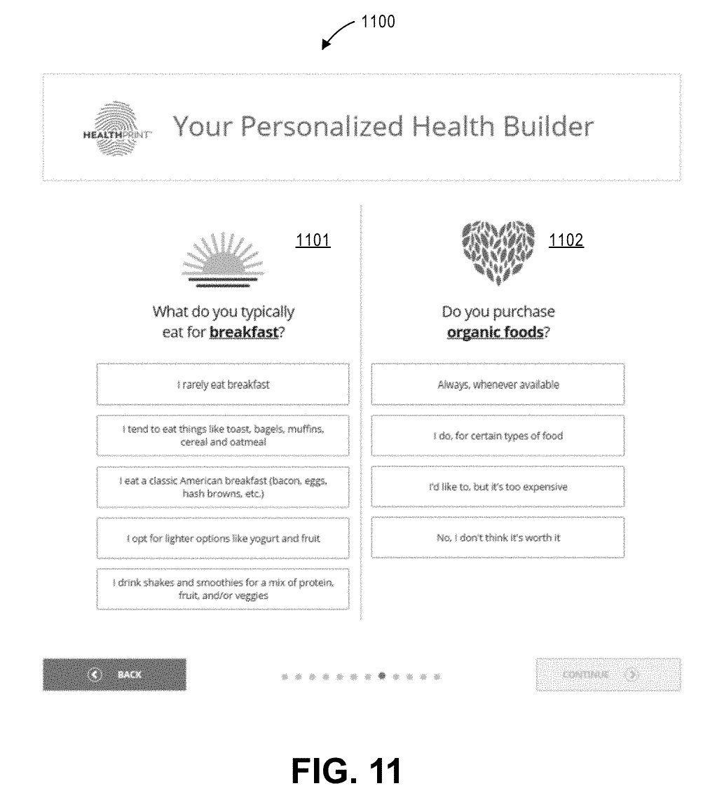

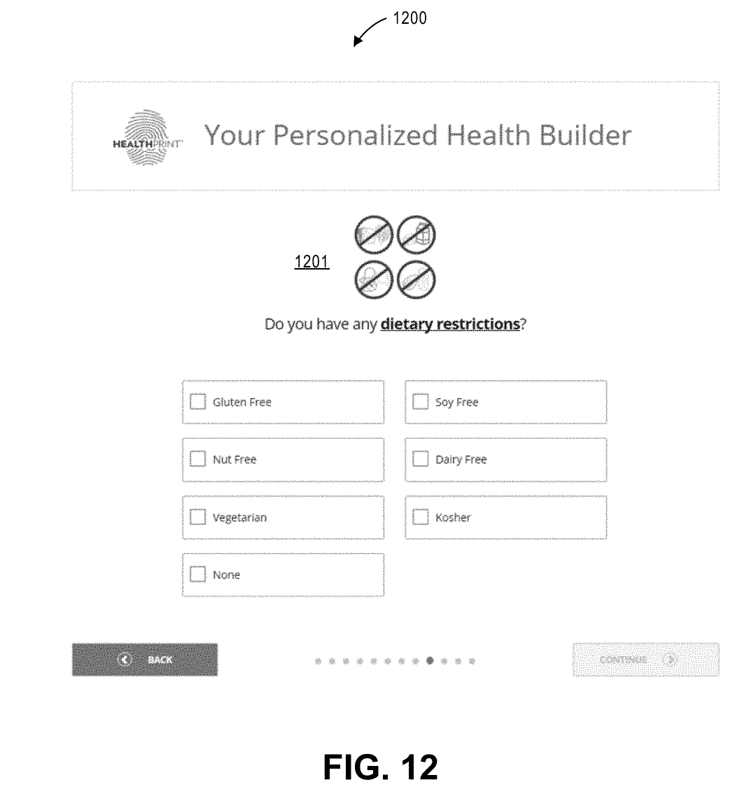

FIG. 10 depicts an interface 1000 that enables the user to select a sugary drink consumption amount (1001) and an unhealthy snack consumption amount (1002). FIG. 11 depicts an interface 1100 that enables the user to select a breakfast description (1101) and an organic food purchase frequency (1102). FIG. 12 depicts an interface 1200 that enables the user to input any dietary restrictions (1201) (as shown: gluten free, soy free, nut free, diary free, vegetarian, kosher, and/or none).

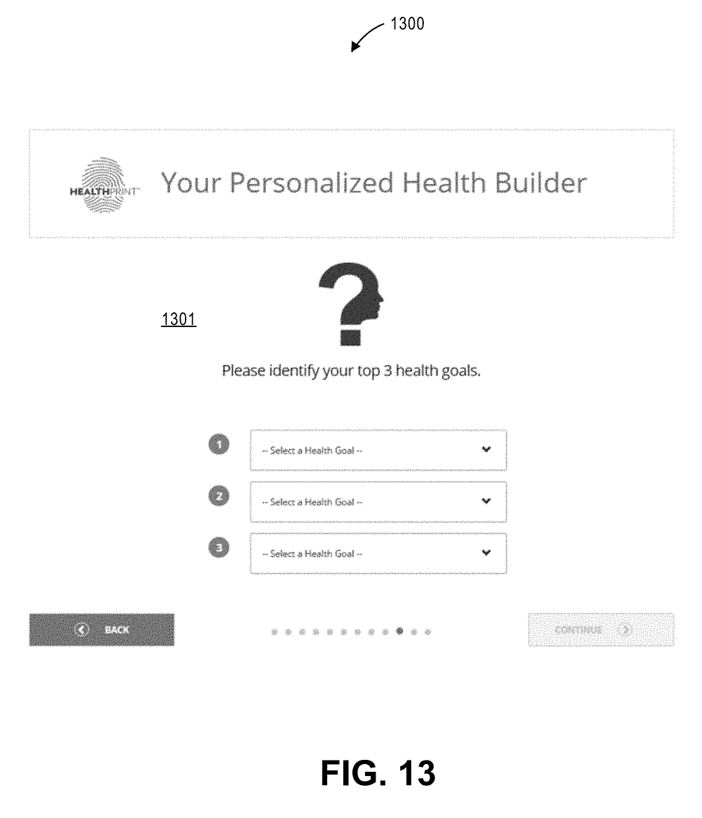

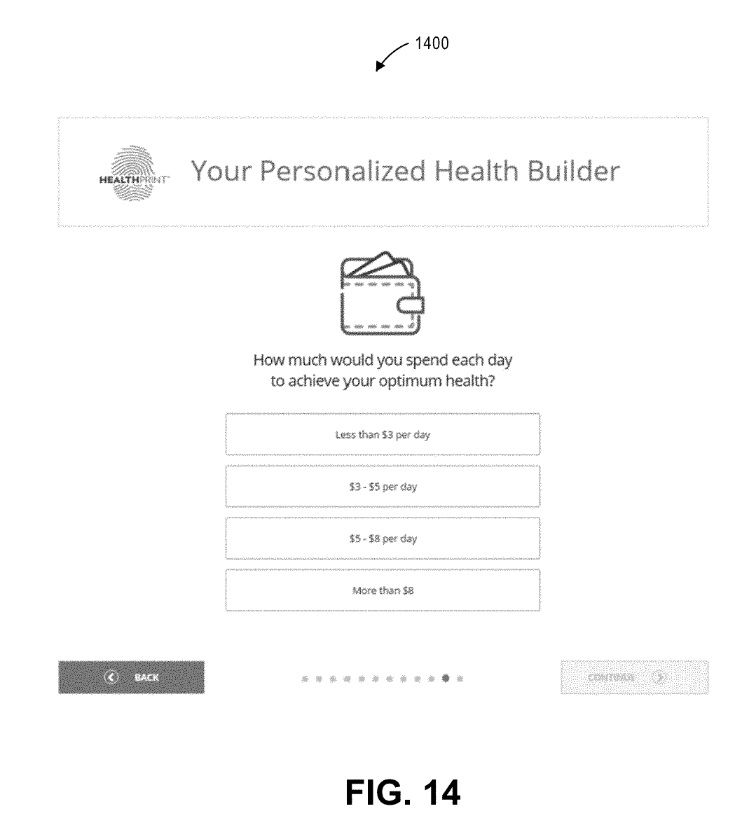

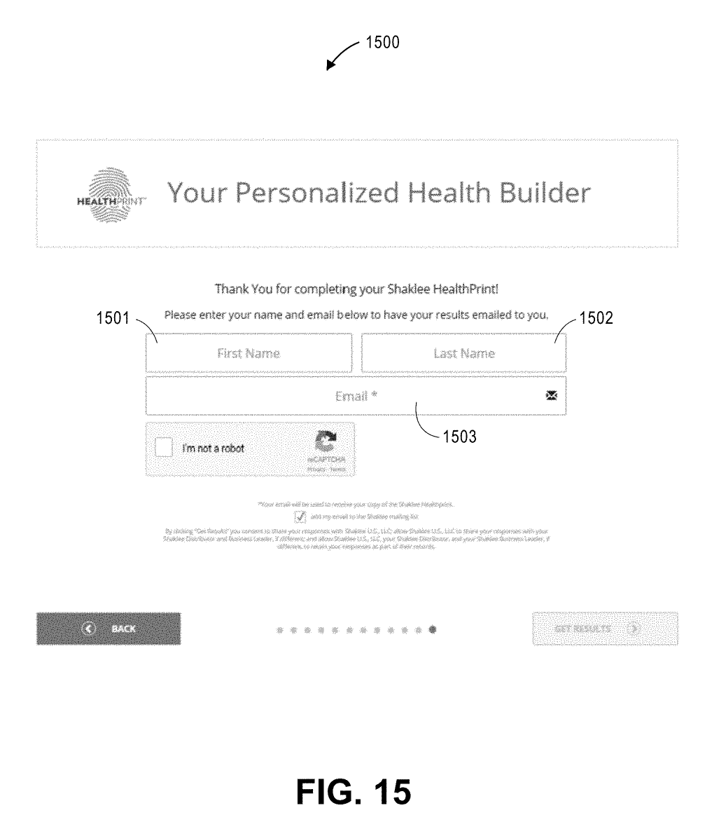

FIG. 13 depicts an interface 1300 that enables the user to identify (1301) up to three health goals. In embodiments, the user may use up to three drop-down menus to select the health goals, which may include any of the following: overall health, healthy heart, joint comfort, strong bones, healthy aging, immune support, sharp memory and focus, more energy, healthy digestion, weight loss, better sleep, stress reduction, and staying fit, and/or other health goals. FIG. 14 depicts an interface 1400 that enables the user to select a desired daily spending amount to achieve optimum health (1401). FIG. 15 depicts an interface 1500 that enables the user to input his/her first name (1501), last name (1502), and email address (1503).

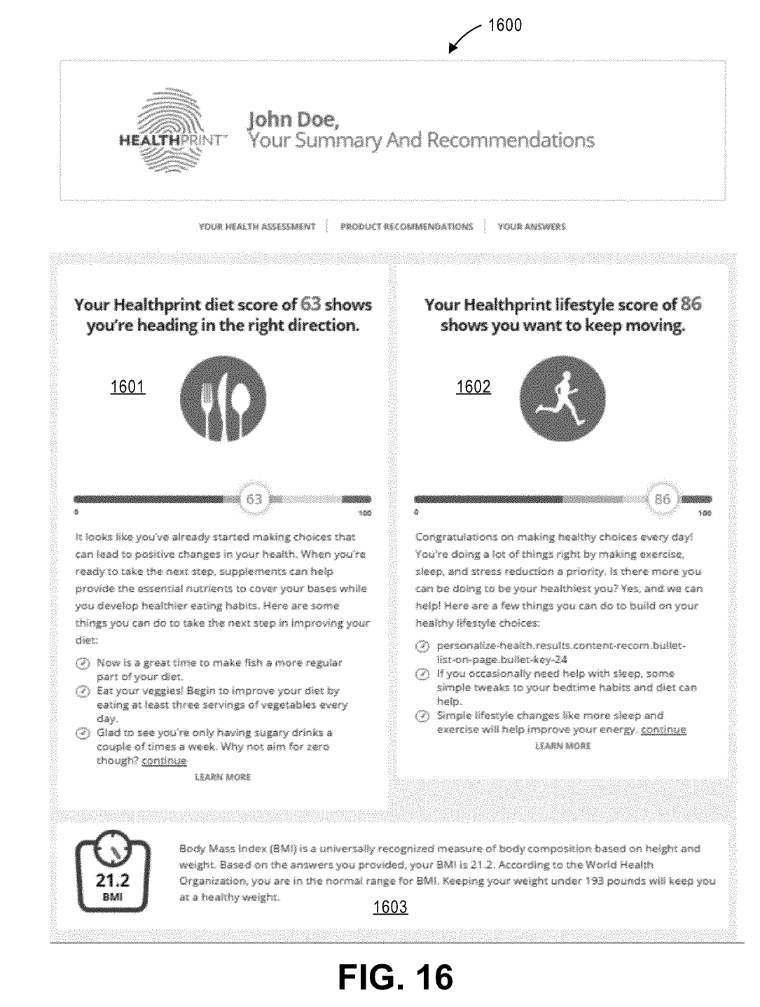

FIG. 16 depicts an interface 1600 that includes a summary and recommendations based on the user selections and responses as discussed with respect to FIGS. 4-14. In an implementation, the back-end server may determine and generate the summary and recommendations of the interface 1600. As depicted in FIG. 16, the interface 1600 may include a section 1601 that indicates a diet score (as shown: 63 out of 100) that may be reflective of a quality of the user's diet, along with a corresponding summary and a set of recommendations for diet improvement. The interface 1600 may further include a section 1602 that indicates a lifestyle score (as shown: 86 out of 100) that may be reflective of a quality of the user's lifestyle and activities, along with a corresponding summary and a set of recommendations for lifestyle improvement. Additionally, the interface 1600 may indicate a body mass index (BMI) (1603) that may be calculated from the user's height and weight.

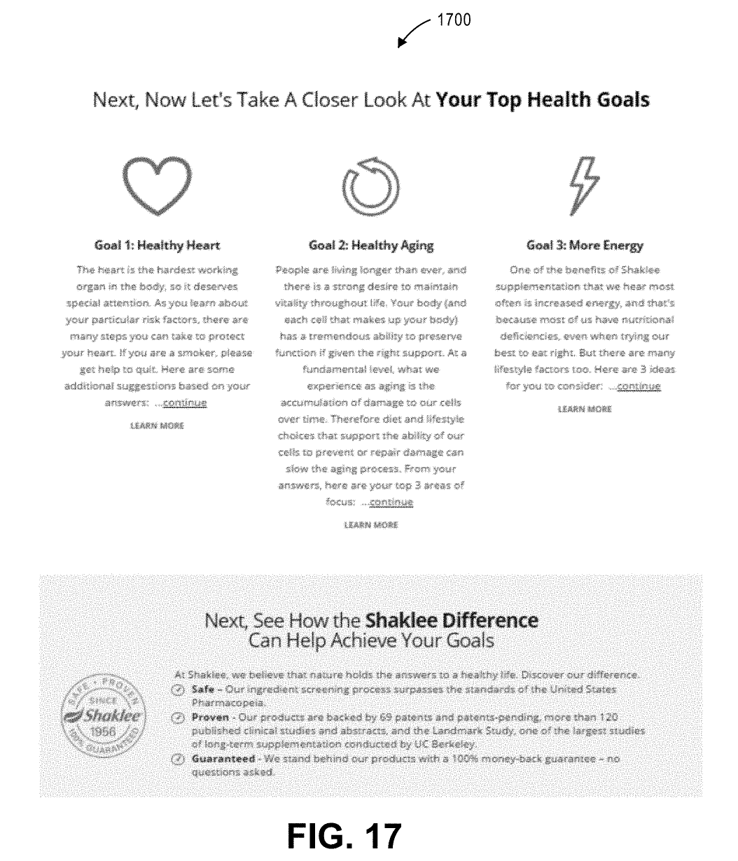

FIG. 17 depicts an interface 1700 that describes top health goals for the user. In embodiments, the top health goals may be general in nature or may be specific to the user based on the user selections and responses as discussed with respect to FIGS. 4A, 4B, and 5-14, and in particular FIG. 13. The example top health goals depicted in the interface 1700 include healthy heart, healthy aging, and more energy.

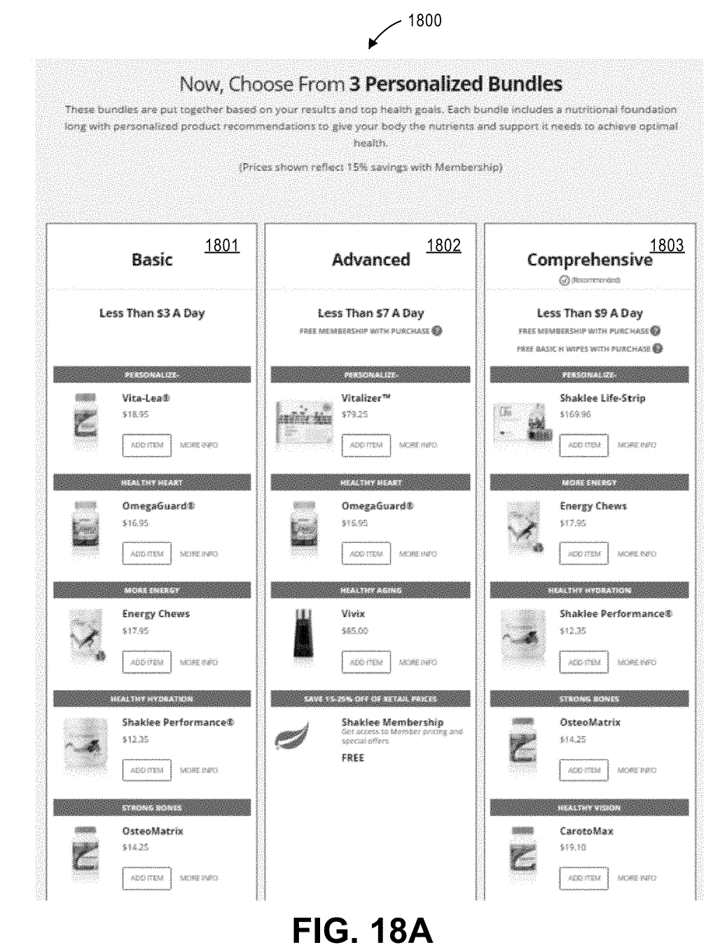

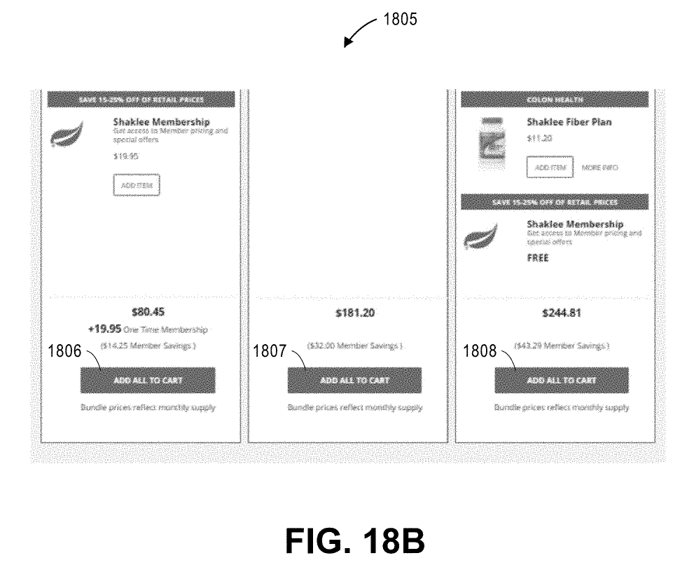

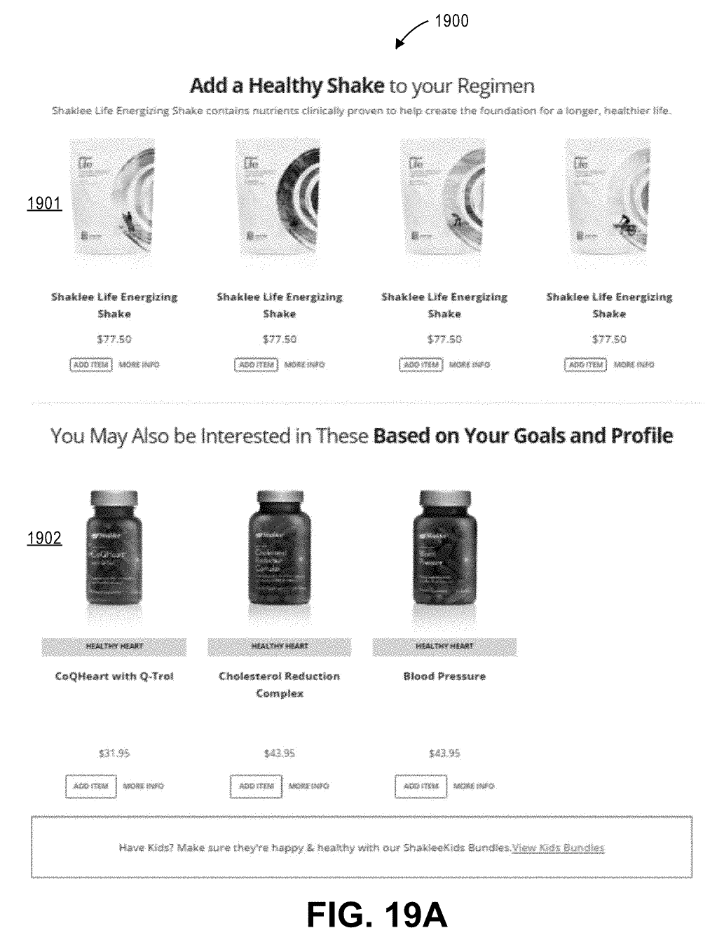

FIG. 18A depicts an interface 1800 that may depict and describe a set of bundles that may each include a set of products and/or a set of services for purposes of improving and maintaining health. In embodiments, the back-end system may determine and compile the set of products and/or the set of services included in the set of bundles according to the inputted user selections and responses. Further, in embodiments, the back-end system may determine the individual bundles based on the extensiveness of the corresponding health regimen. According to embodiments, the products may include nutrients, dietary supplements, herbal products, and/or specific diets or processed food (e.g., cereals, soups, beverages) (generally, nutraceuticals). Further, the services may include one or more membership options that may offer member pricing on products, special offers, early access to sales, information or articles, and/or other benefits.

In the example interface 1800 depicted in FIG. 18A, the three levels of the bundles include basic (1801), advanced (1802), and comprehensive (1803). Each of the bundles may have a corresponding price point or cost (as shown: basic has a cost of less than $3/day, advanced has a cost of less than $7/day, and comprehensive has a cost of less than $9/day). The bundles 1801, 1802, 1803 and the cost thereof may be based on the desired daily spending amount as input in FIG. 14. In embodiments, the corresponding price point or cost may be calculated from the cost of the corresponding products and/or services, the number of corresponding products and/or services, the amount of servings in the products, the consumption frequency recommendation, and/or other factors. The corresponding price point or cost may decrease (or increase) based on which of the products and/or services that the user selects.

FIG. 18B depicts an interface 1805 that is a continuation of the interface 1800 of FIG. 18A. As depicted in FIG. 18B, the interface 1805 may display additional products and/or services for the basic bundle (1801) and the comprehensive bundle (1803). Further, as depicted in FIGS. 18A and 18B, the interfaces 1800, 1805 may enable the user to select one or more of the products and/or services to add the selected one or more products and/or services to a shopping cart for the user. It should be appreciated that the user may select one or more products and/or services from any or all of the basic bundle (1801), the advanced bundle (1802), and the comprehensive bundle (1803). Alternatively, the user may select all of the products and/or services from the basic bundle (1801), the advanced bundle (1802), or the comprehensive bundle (1803) using respective “add all” selections 1806, 1807, 1808. For example, if the user selects the “add all” selection 1807, each of the products and the service included in the advanced bundle (1802) may be added to the shopping cart of the user. Although not shown in the figures, the system may support electronic check-out functionality that may enable the user to place an order for the products and/or services that are included in the shopping cart.

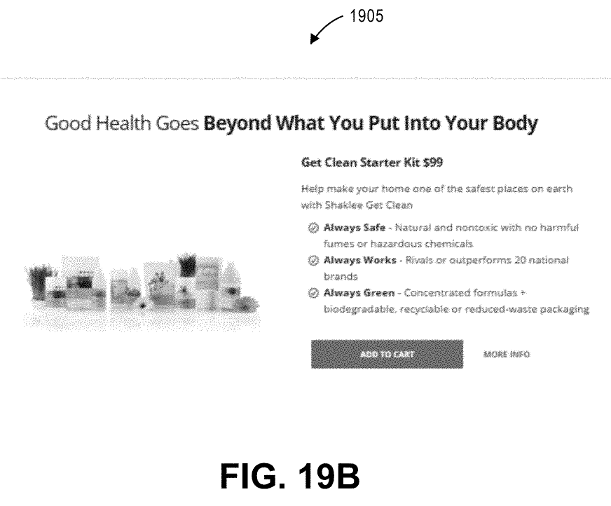

FIG. 19A depicts an interface 1900 that depicts additional products that the user may select to purchase. In particular, the interface 1900 includes a section 1901 indicating a first set of additional products (as shown: various healthy shakes) and a section 1902 indicating a second set of additional products (as shown: various nutraceuticals). The interface 1900 may enable the user to select one or more of the additional products to add to a shopping cart and subsequently purchase. Similarly, FIG. 19B depicts an interface 1905 that depicts additional products (as shown: a starter kit) and that may enable the user to select one or more of the additional products to add to a shopping cart and subsequently purchase.

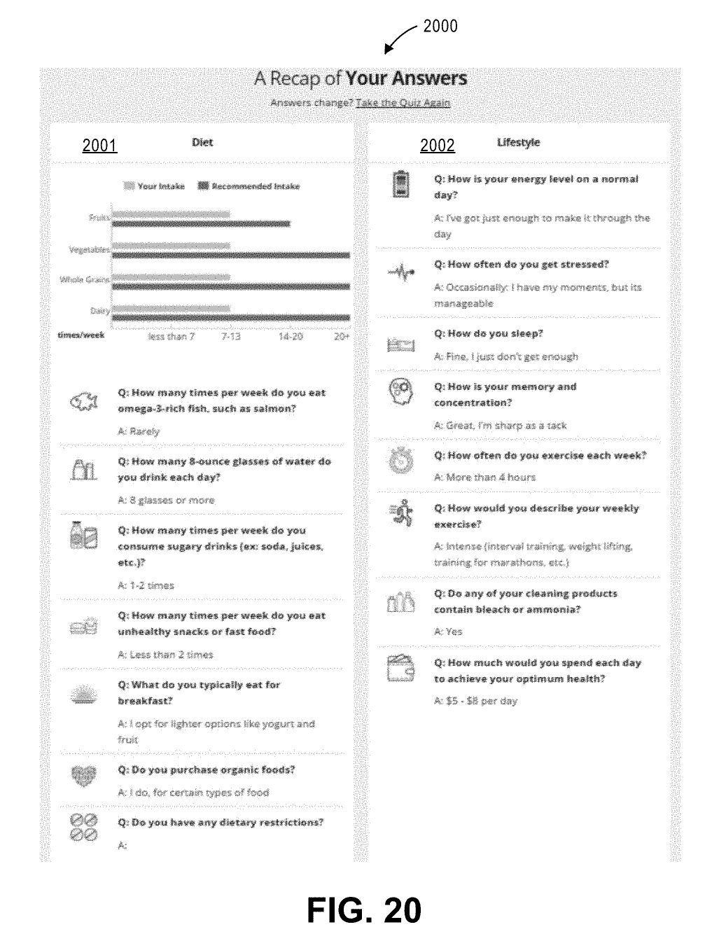

FIG. 20 depicts an interface 2000 that depicts a summary of the answers and information provided by the user. The interface 2000 may include a diet section 2001 that may indicate user-supplied answers related to diet intake relative to recommended diet intake metrics, as well as other user-supplied answers related to diet intake. Similarly, the interface 2000 may include a lifestyle section 2002 that may indicate user-supplied answers related to lifestyle activities and choices.

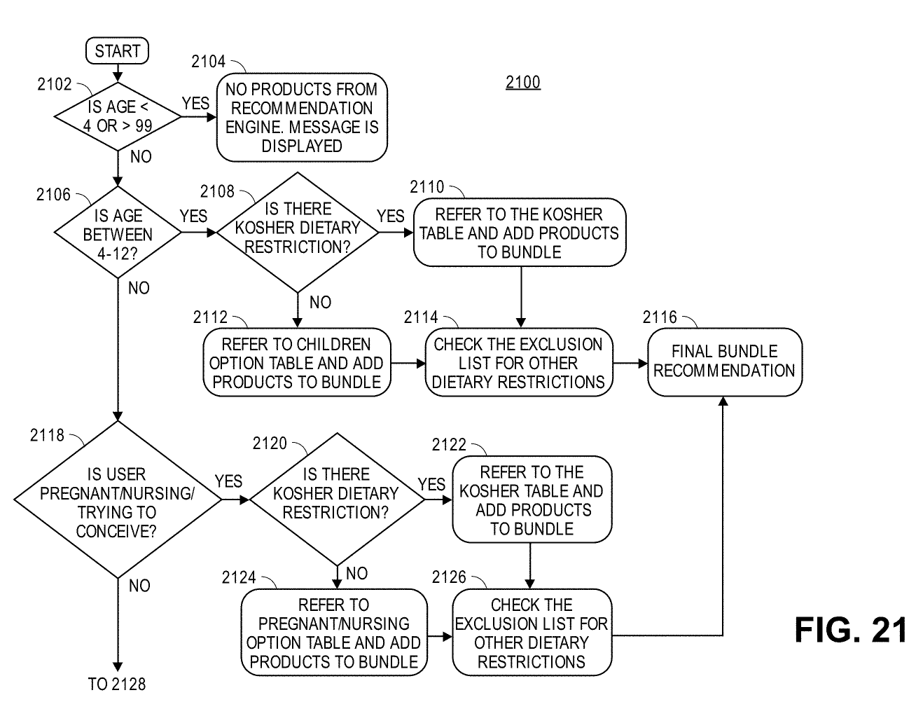

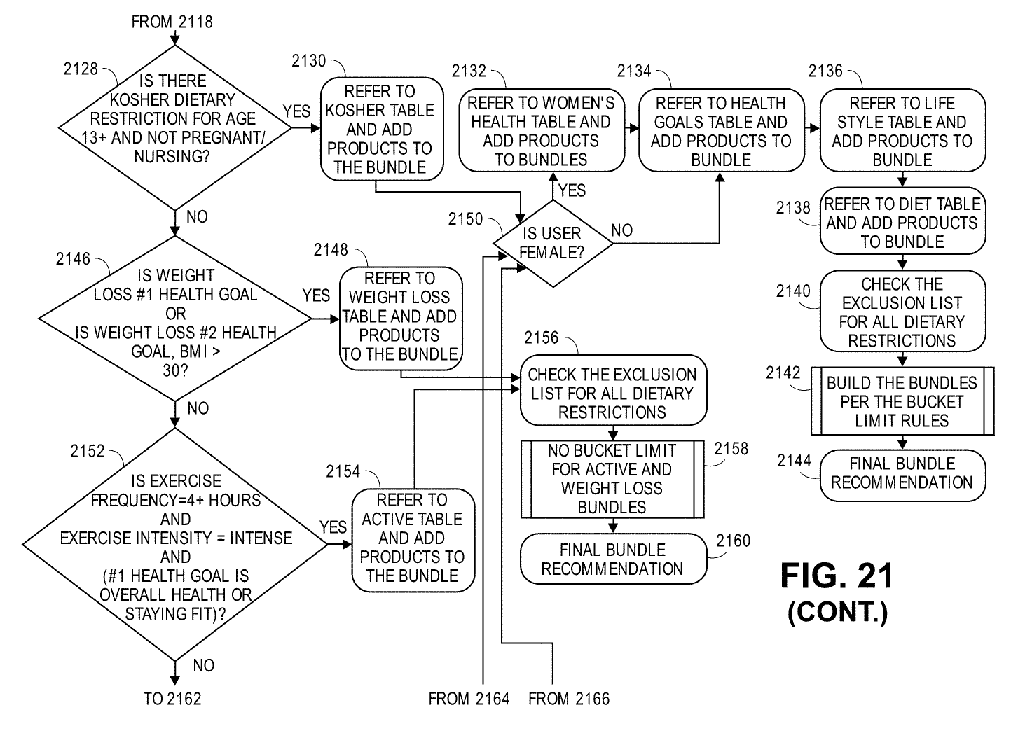

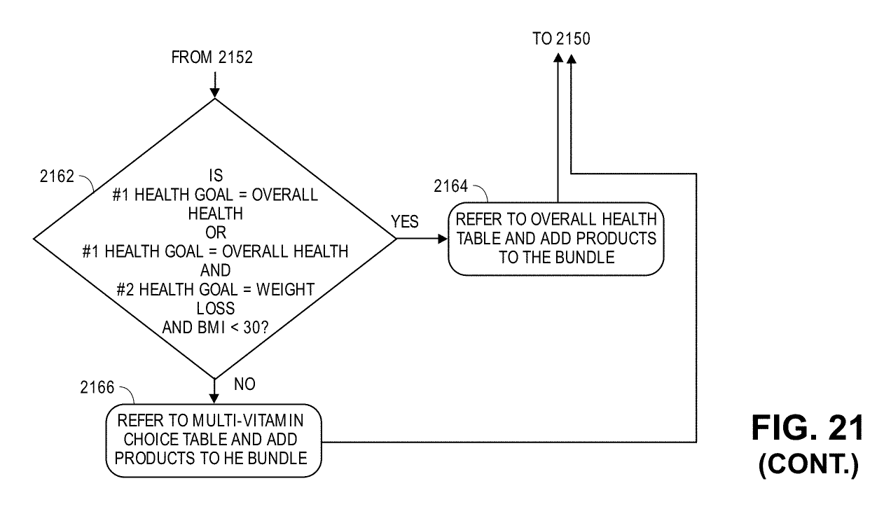

FIG. 21 depicts a block diagram 2100 associated with providing information and dynamically generating health-related recommendations. The block diagram 2100 may be facilitated by one or more electronic devices, such as the server 110 and/or any of the electronic devices 101, 102, 103 as discussed with respect to FIG. 1. Generally, a user may use an electronic device to input information and make selections, and a server may perform various functionalities (e.g., the determinations and generations) based on the information and selections.

The block diagram 2100 may start with the electronic device(s) determining (2102) if the user's age is less than four (4) or greater than ninety-nine (99). If so (“YES”), the electronic device(s) may display (2104) a message indicating that there are no product recommendations. It should be appreciated that the age ranges are merely examples, and that different age ranges are envisioned. If not (“NO”), the electronic device(s) may determine (2106) if the user's age is between four (4) and twelve (12). If so (“YES”), the electronic device(s) may determine (2108) if the user has any kosher dietary restriction, and if so (“YES”), the electronic device(s) may add (2110) products to the bundle based on a kosher table, check (2114) an exclusion list for other dietary restrictions of the user, and generate (2116) a final product bundle recommendation. If the user does not have any kosher dietary restriction (“NO”), the electronic device(s) may add (2112) products to the bundle according to a children option table, check (2114) an exclusion list for other dietary restrictions of the user, and generate (2116) a final product bundle recommendation.

If the user's age is not between four (4) and twelve (12) (“NO”), the electronic device may determine (2118) if the user is pregnant, nursing, or trying to conceive. If so (“YES”), the electronic device(s) may determine (2120) if the user has any kosher dietary restriction, and if so (“YES”), the electronic device may add (2122) products to the bundle based on a kosher table, check (2126) an exclusion list for other dietary restrictions of the user, and generate (2116) a final product bundle recommendation. If the user does not have any kosher dietary restriction (“NO”), the electronic device(s) may add (2124) products to the bundle according to pregnant/nursing option table, check (2126) an exclusion list for other dietary restrictions of the user, and generate (2116) a final product bundle recommendation.

If the user is not pregnant, nursing, or trying to conceive (“NO”), the electronic device(s) may determine (2128) if the user is at least thirteen (13) years old, has kosher dietary restrictions, and is not pregnant, nursing, or trying to conceive. If so (“YES”), the electronic device(s) may add (2130) products to the bundle based on a kosher table and determine (2150) if the user is female. If the user is female (“YES”), the electronic device(s) may add (2132) products to the bundle based on a women's health table, add (2134) products to the bundle based on a health goals table, add (2136) products to the bundle based on a life style table, add (2138) products to the bundle based on a diet table, check (2140) an exclusion list for any dietary restrictions, build (2142) the product bundle(s) based on bucket limit rules, and provide (2144) a final bundle(s) recommendation. If the user is not female (“NO”), the electronic device(s) may skip (2132) and proceed to (2134).

If the determination of (2128) is “NO”, the electronic device(s) may determine (2146) if “weight loss” is the top priority health goal, or if “weight loss” is a secondary health goal with a user having a BMI over thirty (30). If so (“YES”), the electronic device(s) may add (2148) products to the bundle based on a weight loss table, check (2156) an exclusion list for any dietary restrictions, apply (2158) any applicable bucket limit for an active or weight loss bundle, and provide (2160) a final bundle(s) recommendation.

If the determination of (2146) is “NO”, the electronic device(s) may determine (2152) if the user's exercise frequency is greater or equal to four (4) hours, the user's exercise intensity is deemed intense, and the user's top priority health goal is “overall health” or “staying fit.” If so (“YES”), the electronic device(s) may add (2154) products to the bundle based on an active table, check (2156) an exclusion list for any dietary restrictions, apply (2158) any applicable bucket limit for an active or weight loss bundle, and provide (2160) a final bundle(s) recommendation.

If the determination of (2152) is “NO”, the electronic device(s) may determine (2162) if the user's top priority health goal is “overall health”; or if the user's top priority health goal is “overall health”, and the user's secondary health goal is “weight loss” and the user's BMI is greater than thirty (30). If so (“YES”), the electronic device(s) may add (2164) products to the bundle based on an overall health table and determine (2150) if the user is female. If not (“NO”), the electronic device(s) may add (2166) products to the bundle based on a multi-vitamin choice table and determine (2150) if the user is female.

In (2150), if the user is female (“YES”), the electronic device(s) may add (2132) products to the bundle based on a women's health table, add (2134) products to the bundle based on a health goals table, add (2136) products to the bundle based on a life style table, add (2138) products to the bundle based on a diet table, check (2140) an exclusion list for any dietary restrictions, build (2142) the product bundle(s) based on bucket limit rules, and provide (2144) a final bundle(s) recommendation.

In (2150), if the user is not female (“NO”), the electronic device(s) may add (2134) products to the bundle based on a health goals table, add (2136) products to the bundle based on a life style table, add (2138) products to the bundle based on a diet table, check (2140) an exclusion list for any dietary restrictions, build (2142) the product bundle(s) based on bucket limit rules, and provide (2144) a final bundle(s) recommendation.

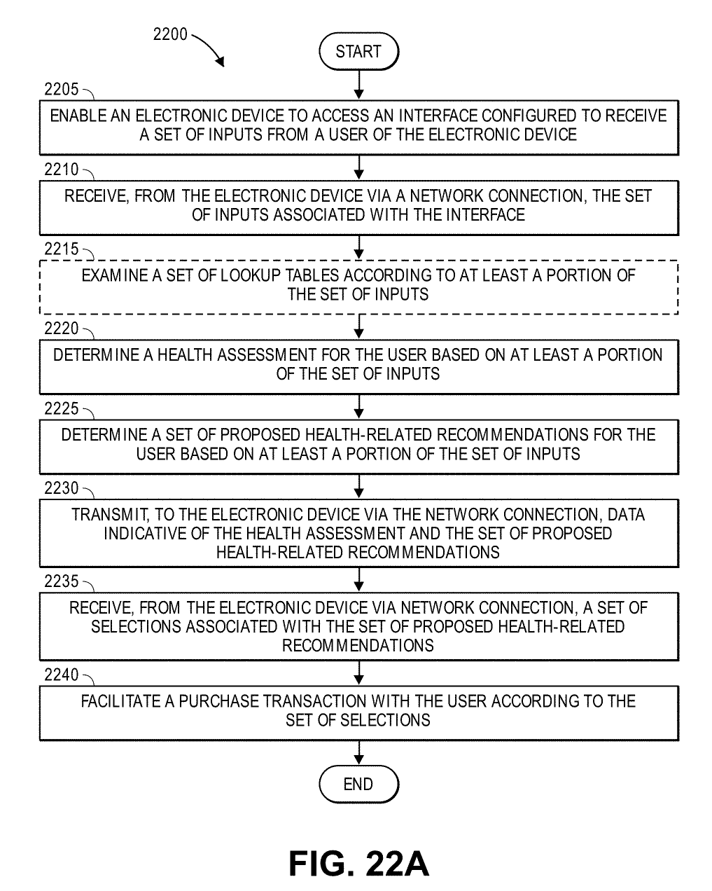

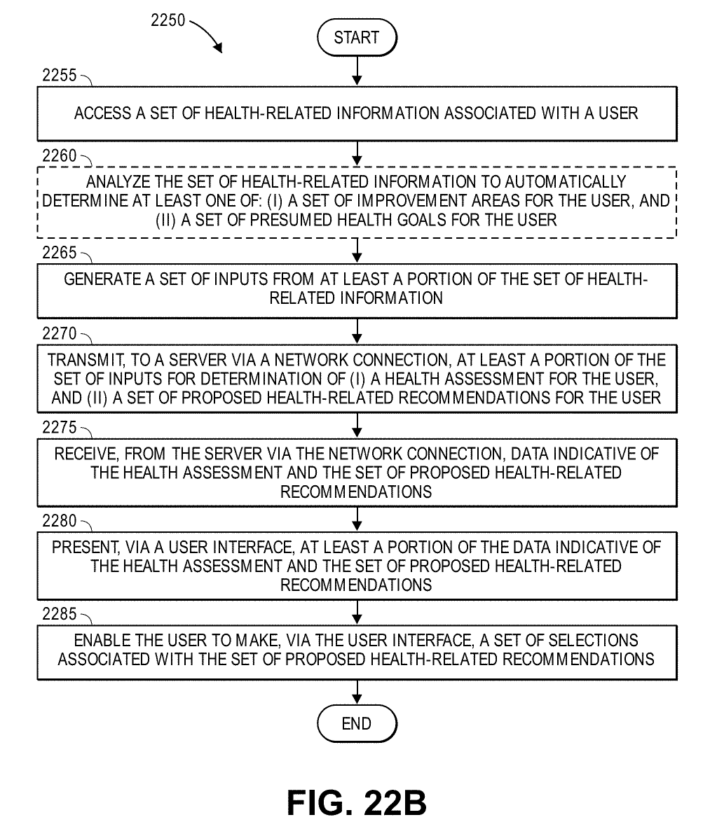

FIG. 22A depicts a block diagram of an example method 2200 of dynamically generating health-related recommendations. The method 2200 may be facilitated by a server, such as the server 110 as discussed with respect to FIG. 1. In particular, the server may support one or more interfaces that may be accessible by an electronic device of a user. The functionality of the method 2200 is merely an example, and it should be appreciated that additional or alternative functionalities are envisioned.

The method 2200 may begin with the server enables (block 2205) an electronic device to access an interface configured to receive a set of inputs from a user of an the electronic device. In embodiments, the electronic device may request to access the interface, such as an interface included as part of a website that the server may host or as part of a dedicated application that the server may support. It should be appreciated that the interface may be composed of a plurality of interface screens.

The server may receive (block 2210), from the electronic device via a network connection, the set of inputs associated with the interface, where the set of inputs may include a set of health-related information associated with the user. In particular, the set of health-related information may include demographic information, anthropometric information, lifestyle information, exercise information, dietary habit information, dietary restriction information, health goal information, and/or desired spending information.

The server may optionally examine (block 2215) a set of lookup tables according to at least a portion of the set of inputs. In embodiments, the set of lookup tables may indicate various products and services available for sale that may be based on at least the portion of the set of inputs. For example, if the user inputs a health goal of “healthy heart,” the server may access a lookup table that includes products tailored for heart health.

The server may determine (block 2220) a heath assessment for the user based on at least a portion of the set of inputs. In determining the health assessment, the server may calculate a lifestyle score (e.g., a numerical score on a scale from 0-100) for the user based on any lifestyle information and exercise information included in the set of inputs, and may calculate a diet score (e.g., a numerical score on a scale from 0-100) for the user based on any dietary habit information included in the set of inputs. Further, the server may determine the health assessment based on the lifestyle score and the diet score.

The server may also determine (block 2225) a set of proposed health-related recommendations for the user based on at least a portion of the set of inputs. In particular, the set of proposed health-related recommendations may vary based on the set of inputs (e.g., the desired spending information), and each proposed health-related recommendation may indicate a set of products and/or services that are available for purchase. It should be appreciated that the server may use different (or the same) portions of the set of inputs in determining the health assessment and the set of proposed health-related recommendations.

The server may transmit (block 2230), to the electronic device via the network connection, data indicative of the health assessment and the set of proposed health-related recommendations. In particular, the data may include numerical score(s) associated with the health assessment and may indicate the products and/or services associated with the set of proposed health-related recommendations. The user may use the electronic device to access and review the data. Additionally, the user may use the electronic device to make selections of any of the products and/or services associated with the set of proposed health-related recommendations.

Accordingly, the server may receive (block 2235), from the electronic device via the network connection, a set of selections of any of the products and/or services associated with the set of proposed health-related recommendations, the set of selections corresponding to products and/or services that the user desires to purchase. The server may accordingly facilitate (block 2240) a purchase transaction with the user according to the set of selections.

FIG. 22B depicts a block diagram of an example method 2250 of dynamically generating health-related recommendations. The method 2250 may be facilitated by an electronic device, such as one of the electronic devices 101, 102, 103 as discussed with respect to FIG. 1. In particular, the electronic device may support an application configured to generate and display a set of interfaces that enable interaction by a user of the electronic device. The functionality of the method 2250 is merely an example, and it should be appreciated that additional or alternative functionalities are envisioned.

The method 2250 may begin with the electronic device accesses (block 2255) a set of health-related information associated with a user. In an implementation, the electronic device may receive the set of health-related information from the user via a user interface of the electronic device.

In another implementation, the electronic device may receive the set of health-related information from an additional electronic device (e.g., a blood pressure monitor, a heart rate monitor, an electrocardiograph monitor, a breathing rate monitor, a sleep monitor, continuous or non-continuous monitors for blood oxygen, blood electrolytes, blood lipids and blood glucose, etc.) via an additional network connection (e.g., a personal area network), where the set of health-related information may be recorded by the additional electronic device. The electronic device may automatically receive the set of health-related information from the additional electronic device in response to the additional electronic device recording the set of health-related information. Alternatively, the electronic device may connect to the additional electronic device via the additional network connection, and may retrieve the set of health-related information from the additional electronic device via the additional network connection.

The electronic device may optionally analyze (block 2260) the set of health-related information to automatically determine at least one of (i) a set of improvement areas for the user, and (ii) a set of presumed health goals for the user. The electronic device may generate (block 2265) a set of inputs from at least a portion of the set of health-related information. In embodiments, the electronic device may generate the set of inputs from the determined set of improvement areas and/or the determined set of presumed health goals.

The electronic device may transmit (block 2270), to a server via a network connection, at least a portion of the set of inputs, where the server may determine (i) a health assessment for the user, and (ii) a set of proposed health-related recommendations for the user. In embodiments, the each of the set of proposed health-related recommendations may indicate a set of products available for purchase by the user.

The electronic device may receive (block 2275), from the server via the network connection, data indicative of the health assessment and the set of proposed health-related recommendations, where the data may further indicate the set(s) of products available for purchase by the user. The electronic device may present (block 2280), via the user interface, at least a portion of the data indicative of the health assessment and the set of proposed health-related recommendations. Additionally, the electronic device may enable (block 2285) the user to make, via the user interface, a set of selections associated with the set of proposed health-related recommendations.

According to embodiments, the systems and methods may support aggregating, compiling, and storing data and information from multiple individuals, where the data and information may be searched, accessed, and reviewed. Additionally, the systems and method may support a social networking service that enables individuals to register and create profiles, where the profiles may include at least a portion of the data and information provided by the individuals. In this regard, the social networking service may connect individuals based on similar or desired health goals or other information. For example, the social networking service may connect two or more individuals who specify “healthy heart” as their primary health goal. Further, the social networking service may enable the individuals to post messages, links, and other information, and generally interact with other individuals.

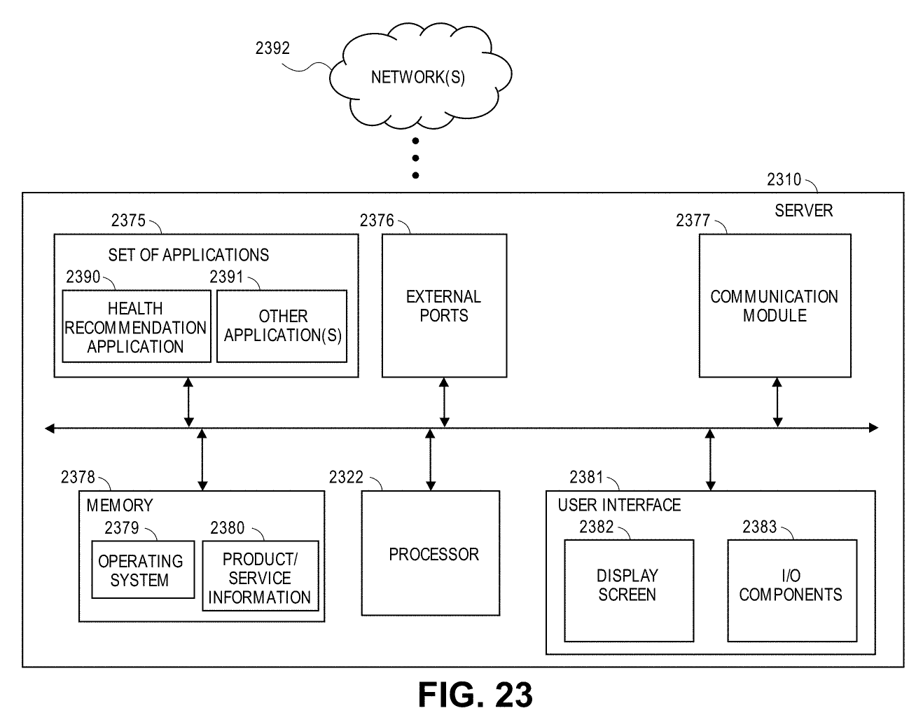

FIG. 23 illustrates a diagram of an example server 2310 (such as the server 110 as discussed with respect to FIG. 1) in which the functionalities as discussed herein may be implemented. It should be appreciated that the server 2310 may be configured to be connect to and communicate with various entities, components, and devices, as discussed herein. In one implementation, the components of the server 2310 may be included in an electronic device.

The server 2310 may include a processor 2322 as well as a memory 2378. The memory 2378 may store an operating system 2379 capable of facilitating the functionalities as discussed herein as well as a set of applications 2375 (i.e., machine readable instructions). For example, one of the set of applications 2375 may be a health recommendation application 2390 configured to determine and generate health-related recommendations based on user-supplied information and inputs. It should be appreciated that one or more other applications 2391 are envisioned.

The processor 2322 may interface with the memory 2378 to execute the operating system 2379 and the set of applications 2375. According to some embodiments, the memory 2378 may also store product and service information 2380 that the health recommendation application 2390 may access to determine and generate health-related recommendations. The memory 2378 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 2310 may further include a communication module 2377 configured to communicate data via one or more networks 2392. According to some embodiments, the communication module 2377 may include one or more transceivers (e.g., WWAN, WLAN, and/or WPAN transceivers) functioning in accordance with IEEE standards, 3GPP standards, or other standards, and configured to receive and transmit data via one or more external ports 2376.

The server 2310 may further include a user interface 2381 configured to present information to a user and/or receive inputs from the user. As shown in FIG. 23, the user interface 2381 may include a display screen 2382 and I/O components 2383 (e.g., ports, capacitive or resistive touch sensitive input panels, keys, buttons, lights, LEDs). According to some embodiments, the user may access the server 2310 via the user interface 2381 to review information and/or perform other functions.

In some embodiments, the server 2310 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 2322 (e.g., working in connection with the operating system 2379) to facilitate the functions as described herein. In this regard, the program code may be implemented in any desired language, and may be implemented as machine code, assembly code, byte code, interpretable source code or the like (e.g., via C, C++, Java, Actionscript, Objective-C, Javascript, CSS, XML). In some embodiments, the computer program product may be part of a cloud network of resources.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

What is claimed is:

1. A computer-implemented method of dynamically generating health-related recommendations, the method comprising:
enabling an electronic device to access an interface configured to receive a set of inputs from a user of the electronic device;
receiving, from the electronic device via a network connection, the set of inputs associated with the interface, the set of inputs including a set of health-related information associated with the user;
determining, by a computer processor based on at least a portion of the set of inputs, (i) a health assessment for the user, and (ii) a set of proposed health-related recommendations for the user, each of the set of proposed health-related recommendations indicating a set of products available for purchase; and
transmitting, to the electronic device via the network connection, data indicative of the health assessment and the set of proposed health-related recommendations, the electronic device configured to enable the user to make a set of selections associated with the set of proposed health-related recommendations.

2. The computer-implemented method of claim 1, wherein receiving the set of inputs associated with the interface comprises:
receiving at least one of: demographic information, anthropometric information, lifestyle information, exercise information, dietary habit information, dietary restriction information, health goal information, and desired spending information.

3. The computer-implemented method of claim 2, wherein analyzing at least the portion of the set of inputs to determine the health assessment for the user comprises:
calculating at least one of: (i) a lifestyle score for the user based on the lifestyle information and the exercise information included in the set of inputs, and (ii) a diet score for the user based on the dietary habit information included in the set of inputs; and
determining the health assessment for the user based on at least one of the lifestyle score and the diet score.

4. The computer-implemented method of claim 3, wherein determining the health assessment for the user is further based on the demographic information and the anthropometric information included in the set of inputs.

5. The computer-implemented method of claim 3, wherein determining the health assessment for the user is further based on the health goal information included in the set of inputs.

6. The computer-implemented method of claim 2, wherein determining the set of proposed health-related recommendations for the user comprises:
determining, based on at least the desired spending information, the set of proposed health-related recommendations for the user, wherein each of the set of proposed health-related recommendations indicates a different price point for the corresponding set of products.

7. The computer-implemented method of claim 6, wherein determining the set of proposed health-related recommendations is further based on the health goal information included in the set of inputs.

8. The computer-implemented method of claim 1, wherein the set of proposed health-related recommendations further indicate a set of services available for purchase.

9. The computer-implemented method of claim 1, further comprising:
receiving, from the electronic device via the network connection, the set of selections associated with the set of proposed health-related recommendations; and
facilitating a purchase transaction with the user according to the set of selections.

10. The computer-implemented method of claim 1, wherein determining (i) the health assessment for the user, and (ii) the set of proposed health-related recommendations for the user comprises:
examining a set of lookup tables according to at least the portion of the set of inputs; and
based on examining the set of lookup tables, determining (i) the health assessment for the user, and (ii) the set of proposed health-related recommendations for the user.

11. The computer-implemented method of claim 1, further comprising:
enabling the user to connect, via a social networking service, with at least one additional user based on at least a portion of the set of proposed health-related recommendations.

12. A server configured to dynamically generate health-related recommendations, comprising:
a transceiver configured to communicate data via at least one network connection;
a memory storing a set of computer-readable instructions; and
a processor interfacing with the transceiver and the memory, and configured to execute the set of computer-readable instructions to cause the processor to:
enable an electronic device to access an interface configured to receive a set of inputs from a user of the electronic device,
receive, from the electronic device via the transceiver, the set of inputs associated with the interface, the set of inputs including a set of health-related information associated with the user,
determine, based on at least a portion of the set of inputs, (i) a health assessment for the user, and (ii) a set of proposed health-related recommendations for the user, each of the set of proposed health-related recommendations indicating a set of products available for purchase, and
transmit, to the electronic device via the transceiver, data indicative of the health assessment and the set of proposed health-related recommendations, the electronic device configured to enable the user to make a set of selections associated with the set of proposed health-related recommendations.

13. The server of claim 12, wherein the set of inputs includes at least one of:
demographic information, anthropometric information, lifestyle information, exercise information, dietary habit information, dietary restriction information, health goal information, and desired spending information.

14. The server of claim 13, wherein to analyze at least the portion of the set of inputs to determine the health assessment for the user, the processor is configured to:
calculate at least one of (i) a lifestyle score for the user based on the lifestyle information and the exercise information included in the set of inputs, or (ii) a diet score for the user based on the dietary habit information included in the set of inputs, and
determine the health assessment for the user based on at least one of the lifestyle score and the diet score.

15. The server of claim 14, wherein the processor determines the health assessment for the user further based on the demographic information and the anthropometric information included in the set of inputs.

16. The server of claim 14, wherein the processor determines the health assessment for the user further based on the health goal information included in the set of inputs.

17. The server of claim 13, wherein to determine the set of proposed health-related recommendations for the user, the processor is configured to:
determine, based on at least the desired spending information, the set of proposed health-related recommendations for the user, wherein each of the set of proposed health-related recommendations indicates a different price point for the corresponding set of products.

18. The server of claim 17, wherein the processor determines the set of proposed health-related recommendations further based on the health goal information included in the set of inputs.

19. The server of claim 12, wherein the set of proposed health-related recommendations further indicate a set of services available for purchase.

20. The server of claim 12, wherein the processor is further configured to:
receive, from the electronic device via the transceiver, the set of selections associated with the set of proposed health-related recommendations, and
facilitate a purchase transaction with the user according to the set of selections.

21. The server of claim 12, wherein to determine (i) the health assessment for the user, and (ii) the set of proposed health-related recommendations for the user, the processor is configured to:
examine a set of lookup tables according to at least the portion of the set of inputs, and
based on examining the set of lookup tables, determine (i) the health assessment for the user, and (ii) the set of proposed health-related recommendations for the user.

22. A computer-implemented method in an electronic device of dynamically generating health-related recommendations, the method comprising:
accessing a set of health-related information associated with a user;
generating a set of inputs from at least a portion of the set of health-related information;
transmitting, to a server via a network connection, at least a portion of the set of inputs, the server configured to determine (i) a health assessment for the user, and (ii) a set of proposed health-related recommendations for the user, each of the set of proposed health-related recommendations indicating a set of products available for purchase;
receiving, from the server via the network connection, data indicative of the health assessment and the set of proposed health-related recommendations;
presenting, via a user interface, at least a portion of the data indicative of the health assessment and the set of proposed health-related recommendations; and
enabling the user to make, via the user interface, a set of selections associated with the set of proposed health-related recommendations.

23. The computer-implemented method of claim 22, wherein accessing the set of health-related information comprises:
receiving the set of health-related information from an additional electronic device via an additional network connection, the set of health-related information recorded by the additional electronic device.

24. The computer-implemented method of claim 23, wherein receiving the set of health-related information from the additional electronic device comprises:
automatically receiving the set of health-related information from the additional electronic device in response to the additional electronic device recording the set of health-related information.

25. The computer-implemented method of claim 23, wherein receiving the set of health-related information from the additional electronic device comprises:
connecting to the additional electronic device via the additional network connection; and
retrieving the set of health-related information from the additional electronic device via the additional network connection.

26. The computer-implemented method of claim 22, wherein generating the set of inputs from at least the portion of the set health-related information comprises:
analyzing the set of health-related information to automatically determine at least one of: (i) a set of improvement areas for the user, and (ii) a set of presumed health goals for the user.

27. The computer-implemented method of claim 22, wherein accessing the set of health-related information associated with the user comprises:
receiving the set of health-related information from the user via the user interface.
